(19) United States
(12) Patent Application Publication
(10) Pub. No.: US 2026/0176425 A1
(43) Pub. Date: Jun. 25, 2026

(54) CURABLE RESIN COMPOSITION

(71) Applicant: SHIN-ETSU CHEMICAL CO., LTD., Tokyo (JP)

(72) Inventors: Yoshihiro NOJIMA, Annaka-shi (JP); Kazuya Tobishima, Annaka-shi (JP); Shinji Aoki, Annaka-shi (JP); Hitoshi Maruyama, Annaka-shi (JP)

(73) Assignee: SHIN-ETSU CHEMICAL CO., LTD., Tokyo (JP)

(21) Appl. No.: 19/126,836

(22) PCT Filed: Oct. 27, 2023
(86) PCT No.: PCT/JP2023/038884

§ 371 Date: May 2, 2025

(30) Foreign Application Priority Data
Nov. 11, 2022 (JP) 2022-181131

(51) Int. Cl. C08G 77/12; C08L 83/04; C09K 11/02

(52) U.S. Cl. CPC C08G 77/12; C08L 83/04; C09K 11/02; C09K 11/025

(57) ABSTRACT

A curable resin composition including a quantum dot, wherein the curable resin composition is a mixture of a thermosetting resin and a silsesquioxane polymer in which the quantum dot is copolymerized with silsesquioxane. This can provide a curable resin composition that can disperse quantum dots at high concentration in a curable resin without aggregation of the quantum dots and contains highly reliable quantum dots.

### TECHNICAL FIELD

The present invention relates to a curable resin composition including a quantum dot.

### BACKGROUND ART

A semiconductor crystal particle with a nanosized particle diameter is called a quantum dot, and a exciton generated upon light absorption is confined in a nanosized region, so that the semiconductor crystal particle has a discrete energy level, and further the band gap varies depending on the particle diameter. Due to these effects, the fluorescence emission by a quantum dot is brighter and more efficient than that by common fluorescent materials and exhibits sharp light emission.

Moreover, based on such nature that the band gap varies depending on the particle diameter, the quantum dot is characterized in that the emission wavelength is controllable and is considered promising to be used in application as a wavelength conversion material for solid-state lighting and a display. For example, the use of quantum dots as a wavelength conversion material of a display can achieve a wider color range and lower power consumption than conventional fluorescent materials.

There has been proposed a method of using quantum dots for a wavelength conversion material, in which quantum dots are dispersed in a resin material and the resin material containing the quantum dot is laminated with a transparent film and then incorporated into a backlight unit as a wavelength conversion film (Patent Document 1).

Furthermore, there has also been proposed an application to image elements with high efficiency and excellent color reproducibility by using a quantum dot as a color filter material so that the quantum dot absorb blue monochromatic light from a backlight unit and emit red or green light to thereby function as a color filter and a wavelength conversion material (Patent Document 2).

A micro LED display, in which the backlight unit is replaced with a micro-sized LED array, has drawn attention. The micro LED display requires a color filter to be formed on a micro-sized LED. A lithography process using a curable material has been proposed as a method for forming a quantum dot color filter on an LED array (Patent Document 3). In recent years, the size of LED array has been miniaturized, and there is a demand for finer patterning of quantum dots than ever before. In addition, in applications as a color filter, it is also necessary to increase light absorption of a color filter in order to prevent leakage of blue monochromatic light, which is excitation light, from the color filter. In order to increase the light absorption of a color filter, it is necessary to increase the quantum dot concentration.

### CITATION LIST

### Patent Literature

Patent Document 1: JP2013-544018A
Patent Document 2: JP2017-021322A
Patent Document 3: JP2021-089347A
Patent Document 4: JP2016-518468A
Patent Document 5: JP2013-505346A
Patent Document 6: JP6283092B2

### Non Patent Literature

Non Patent Document 1: Journal of Photopolymer Science and Technology, Vol 23, 2010, p115-119

### SUMMARY OF INVENTION

### Technical Problem

Generally, curable resin materials such as acrylic resin and silicone resin have polarity and are dispersed in polar solvents such as PGMEA and PGME, so they are poorly compatible with quantum dots, which are basically hydrophobic and cause aggregation, resulting in a major problem also. This aggregation problem becomes even more serious when the concentration of the quantum dots is increased. The quantum dot aggregate interferes with crosslinking of a resin during curing to reduce the curability, and the presence of the aggregate inside a wavelength conversion material obtained by curing this resin composition causes unevenness in emission intensity, adversely affecting product characteristics. Addition of a dispersant has been considered as a measure to prevent the aggregation of quantum dots, but this has problems such as reducing the quantum dot content and causing interference with curing and a coloring problem during a curing process of a curable resin, thereby deteriorating the properties of the cured resin.

In addition, since the quantum dot in a cured resin composition is present in the resin material, unlike in environment in a solution, ligand detachment is likely to occur, thereby resulting in a problem of deteriorated luminous properties caused by changes over time.

To address these problems, various methods have been proposed and tried in order to improve the dispersibility of quantum dots in a polar solvent or a resin material or to improve their stability therein, such as surface coating of a quantum dot (Patent Document 4) or encapsulation of a quantum dot (Patent Document 5), and bonding to a polyhedral oligomeric silsesquioxane ligand (Patent Document 6). However, it is difficult to satisfy simultaneously all of: dispersibility in a resin material; achievement of both stability and inhibition of aggregation at high concentrations at once, particularly when the quantum dot content is 10 parts by mass or more; and curability of the composition mixed with a resin.

The present invention has been made in view of the above-described problem. An object of the present invention is to provide a curable resin composition that can disperse quantum dots at high concentration in a curable resin without aggregation of the quantum dots and contains highly reliable quantum dots.

### Solution to Problem

To solve the problems above, the present invention provides a curable resin composition comprising a quantum dot, wherein the curable resin composition is a mixture of a thermosetting resin and a silsesquioxane polymer in which the quantum dot is copolymerized with silsesquioxane.

Such a curable resin composition can disperse quantum dots at high concentration in a curable resin without aggregation of the quantum dots and can contain highly reliable quantum dots.

Further, the present invention provides a curable resin composition comprising a quantum dot, wherein the curable resin composition is a mixture of a thermosetting resin and a silsesquioxane polymer in which the quantum dot is copolymerized with alkoxysilane.

Even in such a curable resin composition, the quantum dot can be dispersed in the curable resin at a high concentration without quantum dot aggregation, and the curable resin composition contains highly reliable quantum dots.

Further, in the present invention, the quantum dot is preferably surface-modified with a silane coupling agent.

Such a quantum dot easily copolymerizes with silsesquioxane or alkoxysilane and is preferable.

Further, in the present invention, the alkoxysilane preferably comprises two or more kinds of alkoxysilanes each having a different functional group.

With such an alkoxysilane, the degree of crosslinking of the silsesquioxane obtained by the copolymerization can be controlled, and this makes it possible to control the viscosity of the resulting curable resin composition, making it possible to adjust the viscosity in accordance with a manufacturing process.

Further, in the present invention, the alkoxysilane preferably comprises at least one or more kinds of alkoxysilanes of monoalkoxysilane, dialkoxysilane, and trialkoxysilane.

Even with such alkoxysilanes, the degree of crosslinking of the silsesquioxane obtained by the copolymerization can be controlled, and this makes it possible to control the viscosity of the resulting curable resin composition, making it possible to adjust the viscosity in accordance with the manufacturing process.

Further, in the present invention, the silane coupling agent preferably comprises any one or more kinds of an amino group, a thiol group, a carboxy group, a phosphino group, a phosphine oxide group, and an ammonium ion.

Such a silane coupling agent is preferable because it has high coordination with the quantum dot and improves affinity of the quantum dot to the silsesquioxane. It is also preferable because it makes it possible to control the polarity of the quantum dot and the silsesquioxane and improve the dispersibility in the curable resin by adjusting their polarity according to the polarity of the curable resin.

Further, in the present invention, the silsesquioxane preferably has any one or more reactive substituents of a vinyl group, an acrylic group, a methacrylic group, a hydroxy group, a phenolic hydroxy group, an epoxy group, and a glycidyl group, as a functional group.

Such functional groups are preferable from the viewpoint of improving patternability of the curable resin composition.

Further, in the present invention, the alkoxysilane preferably has any one or more reactive substituents of a vinyl group, an acrylic group, a methacrylic group, a hydroxy group, a phenolic hydroxy group, an epoxy group, and a glycidyl group, as a functional group.

Such functional groups are preferable from the viewpoint of improving patternability of the curable resin composition.

Further, in the present invention, the thermosetting resin is preferably an acrylic resin having a (meth)acryloyl group in a side chain.

Such a thermosetting resin can be suitably used for the inventive curable resin composition.

Further, in the present invention, the thermosetting resin is preferably an acid-crosslinkable group-containing silicone resin.

Such a thermosetting resin can be suitably used for the inventive curable resin composition.

### Advantageous Effects of Invention

As described above, the inventive curable resin composition can disperse the quantum dot in a curable resin at a high concentration without quantum dots aggregation, and contains highly reliable quantum dots.

### DESCRIPTION OF EMBODIMENTS

As described above, it has been desired to develop a curable resin composition that can disperse the quantum dot in a curable resin at a high concentration without quantum dot aggregation and contains highly reliable quantum dots.

The present inventors have earnestly studied on the above problems; have conceived mixing a thermosetting resin and a silsesquioxane polymer in which a quantum dot is copolymerized with silsesquioxane; and complete the present invention.

That is, the present invention is a curable resin composition comprising a quantum dot, wherein the curable resin composition is a mixture of a thermosetting resin and a silsesquioxane polymer in which the quantum dot is copolymerized with silsesquioxane.

In addition, the present invention is a curable resin composition comprising a quantum dot, wherein the curable resin composition is a mixture of a thermosetting resin and a silsesquioxane polymer in which the quantum dot is copolymerized with alkoxysilane.

Hereinafter, the present invention will be described in detail, but the present invention is not limited thereto.

In the present invention, a silsesquioxane polymer in which a quantum dot is copolymerized with silsesquioxane or a silsesquioxane polymer in which a quantum dot is copolymerized with alkoxysilane are not those in which the quantum dot is copolymerized directly with the silsesquioxane or the alkoxysilane, but those in which a ligand modified on the surface of the quantum dot is copolymerized with the silsesquioxane or the alkoxysilane. That is, the silsesquioxane polymer is what the quantum dot having a ligand on its surfaces is copolymerized with the silsesquioxane or the alkoxysilane.

In the present invention, compositions and manufacturing methods of the quantum dot are not particularly limited, and a quantum dot according to the purpose can be selected. Examples of the composition of the quantum dot include a II-IV group semiconductor, a III-V group semiconductor, a II-VI group semiconductor, a I-III-VI group semiconductor, a II-IV-V group semiconductor, a IV group semiconductor, and a perovskite-type semiconductor.

Further, the quantum dot may have only a core or a core-shell structure. The particle diameter of the quantum dot may be selected appropriately in accordance with the target wavelength range.

Specific examples of the core material include CdSe, CdS, CdTe, InP, InAs, InSb, AlP, AlAs, AlSb, ZnSe, ZnS, ZnTe, Zn₃P₂, GaP, GaAs, GaSb, CuInSe₂, CuInS₂, CuInTe₂, CuGaSe₂, CuGaS₂, CuGaTe₂, CuAlSe₂, CuAlS₂, CuAlTe₂, AgInSe₂, AgInS₂, AgInTe, AgGaSe₂, AgGaS₂, AgGaTe₂, PbSe, PbS, PbTe, Si, Ge, graphene, CsPbCl₃, CsPbBr₃, CsPbI₃, CH₃NH₃PbCl₃, a mixed crystal thereof, and one obtained by adding a dopant thereto.

Examples of the shell material in the case of a core-shell structure include Zno, ZnS, ZnSe, ZnTe, Cds, CdSe, CdTe, AlN, AlP, AlAs, AlSb, GaN, GaP, GaAs, GaSb, InN, InP, InAs, AlSb, BeS, BeSe, BeTe, MgS, MgSe, MgTe, PbS, PbSe, PbTe, SnS, SnSe, SnTe, CuF, CuCl, CuBr, CuI, and a mixed crystal thereof.

Further, the shape of the quantum dot may be spherical, cubic, or rod-shaped, is not limited, and can be freely selected.

The average particle diameter of the quantum dot is preferably 20 nm or less. When the average particle diameter is 20 nm or less, a quantum size effect can be obtained, emission efficiency is not decreased, and it is possible to control the band gap with the particle diameter.

The particle diameter of the quantum dot can be calculated as an average value of maximum diameters in a predetermined direction, that is, Feret diameter, of 20 or more particles, by measuring a particle image obtained by a transmission electron microscope (TEM). Of course, the method of measuring the average particle diameter is not limited to this, and other methods can be used for the measurement.

Further, the quantum dot surface may have a ligand. From the viewpoint of dispersibility, the ligand preferably has an aliphatic hydrocarbon. Examples of such a ligand include oleic acid, stearic acid, palmitic acid, myristic acid, lauric acid, decanoic acid, octanoic acid, oleylamine, stearyl(octadecyl)amine, dodecyl(lauryl)amine, decylamine, octylamine, octadecanethiol, hexadecanethiol, tetradecanethiol, dodecanethiol, decanethiol, octanethiol, trioctylphosphine, trioctylphosphine oxide, triphenylphosphine, triphenylphosphine oxide, tributylphosphine, and tributylphosphine oxide. One kind of these may be used, or two or more kinds thereof may be used in combination.

The surface of the quantum dot can be surface-modified with a silane coupling agent. The silane coupling agent preferably has an amino group, a thiol group, a carboxyl group, a phosphino group, a phosphine oxide group, and an ammonium ion. Examples of the silane coupling agent include 3-aminopropyltriethoxysilane, 3-aminopropyltrimethoxysilane, aminophenyltrimethoxysilane, N-(2-aminoethyl)-3-aminopropyltriethoxysilane, 3-mercaptopropyltriethoxysilane, 3-mercaptopropyltrimethoxysilane, 3-mercaptopropyl(dimethoxy)methylsilane, triethoxysilylpropylmaleamic acid, [(3-triethoxysilyl)propyl]succinic anhydride, X-12-1135 (manufactured by Shin-Etsu Chemical Co., Ltd.), diethylphosphatoethyltriethoxysilane, 3-trihydroxypropylmethylphosphonate sodium salt, and trimethyl[3-(trimethoxysilyl)propyl]ammonium chloride.

In one embodiment, the quantum dot surface-modified with a silane coupling agent can be copolymerized with silsesquioxane. The copolymerization method is not particularly limited. For example, the surface-modified quantum dot and silsesquioxane are mixed in a mixed solvent of toluene and ethanol, and a small amount of water and a catalyst are added to the mixture to react them, so that the quantum dot and the silsesquioxane can be copolymerized. The kind of the catalyst is not particularly limited, and acids and alkalis may be used. Examples of the catalyst include formic acid, hydrochloric acid, nitric acid, acetic acid, aqueous ammonia, and tetramethylammonium hydroxide.

The structure of the silsesquioxane is not particularly limited and may be a cage structure, a ladder structure, a random structure, or the like, and may be appropriately selected according to the purpose. A random structure is preferable from the viewpoint of dispersibility and uniformity in a curable resin. The functional group contained in the silsesquioxane is not limited and may be appropriately substituted according to the purpose. Substituents capable of performing a crosslinking reaction with a curable resin are particularly preferable as a substituent from the viewpoint of improving the patternability of curable resin composition. Examples of functional groups of the silsesquioxane include a vinyl group, an allyl group, a glycidyl group, a hydroxy group (a hydroxyl group), a phenol group, an acrylic group, a methacrylic group, a thiol group, a phenolic hydroxyl group, and an epoxy group.

In one embodiment, the quantum dot surface-modified with a silane coupling agent are copolymerized with an alkoxysilane to be able to obtain the silsesquioxane polymer. The copolymerization method is not particularly limited. As a synthesis method of the silsesquioxane, known methods include that are described in Non-Patent Document 1. For example, the surface-modified quantum dots and alkoxysilane are mixed in a mixed solvent of toluene and ethanol, and a small amount of water and a catalyst are added to the mixture to react them, thereby to be able to obtain the silsesquioxane polymer. The kind and amount of the catalyst is not particularly limited, and acids and alkalis may be used. Examples of the catalyst include formic acid, hydrochloric acid, nitric acid, acetic acid, aqueous ammonia, and tetramethylammonium hydroxide.

The silane coupling agent is not particularly limited and can be appropriately selected according to the desired resin properties. The silane coupling agent preferably has an amino group, a carboxy group, a phosphino group, a phosphine oxide group, an ammonium ion, a vinyl group, an allyl group, a glycidyl group, a phenyl group, an acryl group, a methacryl group, or a thiol group as a functional group. The silane coupling agent to be used may have not only one kind of functional group but also two or more kinds of functional groups. Examples of the silane coupling agent include trimethoxyvinylsilane, triethoxyvinylsilane, trimethoxy(4-vinylphenyl)silane, allyltriethoxysilane, allyltrimethoxysilane, triethoxy(3-glycidyloxypropyl)silane, 3-glycidyloxypropyltrimethoxysilane, [8-(glycidyloxy)-n-octyl]trimethoxysilane, KBM-573 (manufactured by Shin-Etsu Chemical Co., Ltd.), (3-methacryloyloxypropyl)triethoxysilane, (3-methacryloyloxypropyl)trimethoxysilane, 3-(trimethoxysilyl)propyl acrylate, 3-mercaptopropyltriethoxysilane, and 3-mercaptopropyltrimethoxysilane.

The alkoxysilane may include not only trialkoxysilane but also dialkoxysilane or monoalkoxysilane. The alkoxysilane preferably includes at least one of monoalkoxysilane, dialkoxysilane, and trialkoxysilane. The trialkoxysilane, the dialkoxysilane, and the monoalkoxysilane may have the same functional group or different functional groups. The alkoxysilane preferably includes two or more kinds of alkoxysilanes each having a different functional group. By including the dialkoxysilane or the monoalkoxysilane, the degree of crosslinking of the silsesquioxane obtained by the copolymerization can be controlled; thereby the viscosity of the curable resin composition to be obtained can be controlled; and the viscosity can be adjusted according to the manufacturing process. The kind and ratio of these alkoxysilanes are not particularly limited and can be appropriately selected according to the purpose. The alkoxysilane preferably has, as a functional group, one or more reactive substituents of a vinyl group, an acrylic group, a methacrylic group, a hydroxy group, a phenolic hydroxy group, an epoxy group, and a glycidyl group.

The inventive curable resin composition is a mixture of a silsesquioxane polymer and a thermosetting resin. The thermosetting resin contains a polymer as a base polymer and a polymerization initiator, and, in addition to these, may also contain a solvent, a polymerizable crosslinking agent, a photoacid generator, an antioxidant, a light scattering agent, etc. The thermosetting resin is preferably an acrylic resin having a (meth)acryloyl group in a side chain or an acid-crosslinkable group-containing silicone resin. As the polymer, it is possible to use suitably: polymers each derived from acrylic acid, methacrylic acid, acrylic acid esters, or methacrylic acid esters as well as copolymers combining thereof; polymers containing glycidyl (meth)acrylate in the repeating unit; and polymers having a siloxane skeleton, a urethane skeleton, a silphenylene skeleton, a norbornene skeleton, a fluorene skeleton, or an isocyanurate skeleton. The polymer to be used may be selected appropriately according to the intended application. Examples thereof include acrylic resins; alkyd resins; melamine resins; epoxy resins; silicone resins; polyvinyl alcohols; polyvinylpyrrolidones; polyimide precursors, such as polyamides, polyamide-imides, and polyimides and esterification products thereof; and reaction products of tetracarboxylic dianhydrides and diamines. In addition, a polymerizable substituent is introduced into these polymers, so that they can be cured by combined use with a polymerization initiator. Radical polymerizable substituents include a vinyl group, an acrylic group, a methacrylic group, and a thiol group, all of which can be suitably used. Cationic polymerizable substituents include a hydroxy group, a phenolic hydroxy group, an epoxy group, a glycidyl group, an oxetanyl group, and an isocyanate group, all of which can be suitably used.

Further, the inventive curable resin composition preferably contains a polymerization initiator also. The polymerization initiators include a thermal polymerization initiator, any of which may be suitably used in accordance with the base polymer. Examples of the thermal polymerization initiator include AIBN, BPO, TA-100, and IK-1 (manufactured by San-Apro Co., Ltd.). In addition, the composition may contain a known thermal radical polymerization initiator or a known thermal cationic polymerization initiator, which is not particularly limited.

The content of the polymerization initiator is preferably 0.1 to 10 parts by mass, and more preferably 0.2 to 5 parts by mass, based on 100 parts by mass of the polymer to be added.

The inventive curable resin composition may contain a solvent to improve its coatability. From the viewpoint of dispersibility of the quantum dot, the solvent is preferably an organic solvent, such as ketones, alkylene glycol ethers, alcohols, and aromatic compounds. Examples thereof that can be used suitably includes: ketones, such as acetone, methyl ethyl ketone, and cyclohexanone; alkylene glycol ethers, such as methyl cellosolve (ethylene glycol monomethyl ether), butyl cellosolve (ethylene glycol monobutyl ether), methyl cellosolve acetate, ethyl cellosolve acetate, butyl cellosolve acetate, ethylene glycol monopropyl ether, ethylene glycol monohexyl ether, ethylene glycol dimethyl ether, diethylene glycol ethyl ether, diethylene glycol diethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol tert-butyl ether acetate, triethylene glycol methyl ether acetate, triethylene glycol ethyl ether acetate, triethylene glycol propyl ether acetate, triethylene glycol isopropyl ether acetate, triethylene glycol butyl ether acetate, and triethylene glycol tert-butyl ether acetate; alcohols, such as methyl alcohol, ethyl alcohol, isopropyl alcohol, n-butyl alcohol, and 3-methyl-3-methoxybutanol; and aromatic compounds, such as benzene, toluene, and xylene.

Further, the inventive curable resin composition may further contain a polymerizable crosslinking agent, an antioxidant, a light scattering agent, and the like.

By mixing the above-mentioned thermosetting resin with a silsesquioxane polymer in which the quantum dot is copolymerized with a silsesquioxane or a silsesquioxane polymer in which the quantum dot is copolymerized with an alkoxysilane, it is possible to obtain a curable resin composition containing the quantum dot of the target.

The content of the quantum dot can be adjusted appropriately depending on the desired luminous properties. The concentration of the quantum dot is preferably adjusted so that the absorptance of the excitation light is 90% or more. Although the optimal concentration varies depending on the properties of the quantum dot, the concentration is particularly preferably 10 parts by mass or more based on 100 parts by mass of the curable resin composition.

The curable resin composition containing the quantum dot manufactured by the above method is applied onto a substrate and then exposed and developed to obtain a wavelength conversion material for color filters. The method for manufacturing the wavelength conversion material is not particularly limited and can be appropriately selected according to the required characteristics and processes. For example, the wavelength conversion material can be obtained by applying the curable resin composition onto a transparent film or a substrate material, such as PET and polyimide, and curing the composition.

For the application onto the transparent film, it is possible to use spraying methods such as spraying and inkjet, a spin-coating method, or a bar-coating method.

The method for curing the curable resin composition is not particularly limited, but for example, the curable resin composition can be cured by heating a film coated by the curable resin composition at 60° C. for 2 hours and then heating at 150° C. for 4 hours. The method can be appropriately changed according to the intended use.

### EXAMPLE

Hereinafter, the present invention will be specifically described with reference to Examples and Comparative Examples. However, the present invention is not limited thereto. In these embodiments, a core-shell quantum dot of InP/ZnSe/ZnS was used as the quantum dot material.

### (Synthesis Process of Quantum Dot Core)

0.23 g (0.9 mmol) of palmitic acid, 0.088 g (0.3 mmol) of indium acetate, and 10 mL of 1-octadecene were added to a flask, and the mixture was heated and stirred at 100° C. under reduced pressure and degassed for 1 hour while dissolving the materials. Then, nitrogen was purged into the flask, and 0.75 mL (0.15 mmol) of a solution prepared by mixing tristrimethylsilylphosphine with trioctylphosphine to give a 0.2 M solution was added thereto; the temperature was raised to 300° C.; and it was confirmed that the solution changed color from yellow to red and that core particles were formed.

### (Synthesis Process of Quantum Dot Shell Layer)

Next, 2.85 g (4.5 mmol) of zinc stearate and 15 mL of 1-octadecene were added to another flask, and the mixture was heated and stirred at 100° C. under reduced pressure, and degassed for 1 hour while dissolving the zinc stearate, thereby to prepare a 0.3 M zinc stearate octadecene solution. 3.0 mL (0.9 mmol) of the 0.3 M zinc stearate octadecene solution was added to the reacted solution having the core synthesized and the resultant mixture was cooled to 200° C. Next, 0.474 g (6 mmol) of selenium and 4 mL of trioctylphosphine were added to another flask, and the mixture was heated to 150° C. for dissolving them, thereby to prepare a 1.5 M selenium trioctylphosphine solution. While increasing the temperature of the reacted solution after the core synthesis process, which had been cooled to 200° C., to 320° C. over 30 minutes, the reacted solution was added with the selenium trioctylphosphine solution in 0.1 mL increments to a total of 0.6 mL (0.9 mmol), maintained at 320° C. for 10 minutes, and then cooled to room temperature. 0.44 g (2.2 mmol) of zinc acetate was added thereto and dissolved by heating and stirring at 100° C. under reduced pressure. The flask was purged again with nitrogen and heated to 230° C., added with 0.98 mL (4 mmol) of 1-dodecanethiol, and held for 1 hour. The obtained solution was cooled to room temperature to prepare a solution containing core-shell type quantum dots including InP/ZnSe/ZnS.

### (Surface Treatment of Quantum Dot)

After the reaction was completed, the reacted solution was cooled to room temperature and was added with ethanol to make precipitate in the reacted solution, which was then centrifuged to remove the supernatant. The same purification process was repeated again, and the resultant was dispersed in toluene. The toluene solution of the quantum dot was placed in a flask of which content is replaced with nitrogen. 0.24 mL (1.0 mmol) of (3-mercaptopropyl)triethoxysilane was added thereto and stirred at room temperature for 24 hours.

### (Silsesquioxane Copolymerizing Process)

10 mL of (3-methacryloyloxypropyl)trimethoxysilane, 20 mL of toluene, and 10 mL of methanol were mixed in a flask of which content is replaced with nitrogen, and 4.0 mL of 1.0 N hydrochloric acid was added thereto dropwise little by little while stirring at room temperature. After the dropwise addition, the mixture was stirred at room temperature for 60 minutes, and the solution temperature was increased to 60° C. and refluxed to be reacted for 60 minutes. The system was then evacuated for 2 hours at 60° C. to distill off the solvent. Silsesquioxane having a methacryl group was obtained in the flask.

### (Copolymerization of Quantum Dot and Silsesquioxane)

The obtained silsesquioxane and the surface-treated quantum dot solution were added to a flask of which content is replaced with nitrogen so that the solid content concentration was 20 masse, and 20 mL of toluene and 10 mL of methanol were further added and mixed. 4.0 mL of 1.0 N hydrochloric acid was added dropwise thereto little by little while stirring at room temperature.

After the dropwise addition, the mixture was stirred at room temperature for 60 minutes; the solution temperature was then increased to 60° C.; and the mixture was further allowed to react for 60 minutes under reflux. Thereafter, the system underwent nitrogen flow at 40° C. to distill off the solvent, and thereby to obtain a copolymer 1 of the quantum dot and the silsesquioxane.

### (Copolymerization 1 of Quantum Dot and Alkoxysilane)

7 mL of (3-methacryloyloxypropyl)trimethoxysilane, 3 mL of ethoxytrimethylsilane, and the surface-treated quantum dot solution were added to a flask of which content is replaced with nitrogen so that the solid content concentration was 20 mass %, and 20 mL of toluene and 10 mL of methanol were further added thereto and mixed. 4.0 mL of 1.0 N hydrochloric acid was added dropwise thereto little by little while stirring at room temperature.

After the dropwise addition, the mixture was stirred at room temperature for 60 minutes; the solution temperature was then increased to 60° C.; and the mixture was further allowed to react for 60 minutes under reflux. Thereafter, the system underwent nitrogen flow at 40° C. to distill off the solvent, and thereby to obtain a copolymer 2 of the quantum dot and the silsesquioxane.

### (Copolymerization 2 of Quantum Dot and Alkoxysilane)

4 mL of (3-methacryloyloxypropyl)trimethoxysilane, 3 mL of phenyltrimethoxysilane, 3 mL of ethoxytrimethylsilane, and the surface-treated quantum dot solution were added to a flask of which content is replaced with nitrogen so that the solid content concentration was 20 mass %, and 20 ml of toluene and 10 mL of methanol were further added thereto and mixed. 4.0 mL of 1.0 N hydrochloric acid was added dropwise thereto little by little while stirring at room temperature.

After the dropwise addition, the mixture was stirred at room temperature for 60 minutes; the solution temperature was then increased to 60° C.; and the mixture was further allowed to react for 60 minutes under reflux. Thereafter, the system underwent nitrogen flow at 40° C. to distill off the solvent, and thereby to obtain a copolymer 3 of the quantum dot and the silsesquioxane.

### Example 1

The copolymer 1 of the quantum dot and the silsesquioxane and an acrylic resin RA-4101 (Negami Chemical Industrial Co., Ltd) were weighed out so that 20 parts by mass of the quantum dots was contained in a non-volatile component ratio; 1 part by mass of AIBN was weighed out based on 100 parts by mass of the non-volatile component of the acrylic resin; and these were mixed.

### Example 2

The copolymer 2 of the quantum dot and the silsesquioxane and an acrylic resin RA-4101 (Negami Chemical Industrial Co., Ltd) were weighed out so that 20 parts by mass of the quantum dots was contained in a non-volatile component ratio; 1 part by mass of AIBN was weighed out based on 100 parts by mass of the non-volatile component of the acrylic resin; and these were mixed.

### Example 3

The copolymer 3 of the quantum dot and the silsesquioxane and an acrylic resin RA-4101 (Negami Chemical Industrial Co., Ltd) were weighed out so that 20 parts by mass of the quantum dots was contained in a non-volatile component ratio; 1 part by mass of AIBN was weighed out based on 100 parts by mass of the non-volatile component of the acrylic resin; and these were mixed.

### Example 4

The copolymer 1 of the quantum dot and the silsesquioxane and an epoxy-containing silicone resin (CAS No. 2253674-54-1, manufactured by Shin-Etsu Chemical Co., Ltd.) were weighed out so that 20 parts by mass of the quantum dots was contained in a non-volatile component ratio and mixed. 2 parts by mass of a thermal acid generator TA-100 and 20 parts by mass of a crosslinking agent THI-DE were weighed out based on 100 parts by mass of the non-volatile component of the silicone resin and were mixed therewith.

### Example 5

The copolymer 2 of the quantum dot and the silsesquioxane and an epoxy-containing silicone resin (CAS No. 2253674-54-1, manufactured by Shin-Etsu Chemical Co., Ltd.) were weighed out so that 20 parts by mass of the quantum dot was contained in a non-volatile component ratio and mixed. 2 parts by mass of a thermal acid generator TA-100 and 20 parts by mass of a crosslinking agent THI-DE were weighed out based on 100 parts by mass of the non-volatile component of the silicone resin and were mixed therewith.

### Example 6

The copolymer 3 of the quantum dot and the silsesquioxane and an epoxy-containing silicone resin (CAS No. 2253674-54-1, manufactured by Shin-Etsu Chemical Co., Ltd.) were weighed out so that 20 parts by mass of the quantum dot was contained in a non-volatile component ratio and mixed. 2 part by mass of a thermal acid generator TA-100 and 20 part by mass of a crosslinking agent THI-DE were weighed out based on 100 parts by mass of the non-volatile component of the silicone resin and were mixed therewith.

### Comparative Example 1

The quantum dot that was subjected only to a surface treatment and an acrylic resin RA-4101 (Negami Chemical Industrial Co., Ltd) were weighed out so that 20 parts by mass of the quantum dot was contained in a non-volatile component ratio; 1 part by mass of AIBN was weighed out based on 100 parts by mass of the non-volatile component of the acrylic resin; and these were mixed.

### Comparative Example 2

The quantum dot that was subjected only to a surface treatment and an epoxy-containing silicone resin (CAS No. 2253674-54-1, manufactured by Shin-Etsu Chemical Co., Ltd.) were weighed out so that 20 parts by mass of the quantum dot was contained in a non-volatile component ratio and mixed. 2 parts by mass of a thermal acid generator TA-100 and 20 parts by mass of a crosslinking agent THI-DE were weighed out based on 100 parts by mass of the non-volatile component of the silicone resin and mixed.

The quantum dot-containing curable resin composition obtained in Examples 1 to 6 and Comparative Example 1 to 2 were used to each prepare a wavelength conversion material. The quantum dot-containing curable resin composition was applied onto a glass substrate, and after removing solvents, a semiconductor nanoparticle resin layer with a thickness of 50 μm was formed using a bar coater. Further, the layer was heated at 120° C. for 5 minutes to cure the semiconductor nanoparticle resin layer, preparing a wavelength conversion material.

### (Evaluation of Dispersibility)

Presence of aggregates in the cured resin film was checked with an optical microscope. A sample having aggregate with a size of 1 μm or more was judged “Bad”, and a sample having no aggregate or aggregate with a size of less than 1 μm was judged “Good”.

### (Evaluation of Curability)

Regarding curability of the resin cured film, spectrum measurement was performed before and after curing using a Fourier transform infrared spectrophotometer (FT/IR-4600, manufactured by JASCO Corporation), and a curing ratio was determined based on change in peak height attributable to a functional group related to curing. The curing ratio was defined by (Formula 1) where A1 is the peak intensity before curing and A2 is the peak intensity after curing.

Curing ratio (%)=(A1−A2)/A1×100 (Formula 1)

The curing ratio was calculated using an acrylic group as the functional group in Examples 1 to 3 and Comparative Example 1, and an epoxy group as the functional group in Examples 4 to 6 and Comparative Example 2.

### (Evaluation of Luminous Properties)

For evaluation of luminous properties of the wavelength conversion material, the emission wavelength, fluorescence emission half band width, and fluorescence emission efficiency (internal quantum efficiency) of the quantum dots were measured at an excitation wavelength of 450 nm using a quantum efficiency measurement system (QE-2100) manufactured by Otsuka Electronics Co., Ltd.

### (Evaluation of Reliability)

The obtained pattern was treated at 85° C. and 85% RH (relative humidity) for 250 hours, and a quantum yield after the treatment was measured to confirm the rate of decrease from the initial value and evaluate its reliability.

In Table 1, values of the fluorescence emission efficiency after the wavelength conversion materials of the Examples and Comparative Examples were prepared and after the evaluation of reliability of the Examples and Comparative Examples.

TABLE 1

| | | Example | Example | Example | Example | Example | Example | Comparative | Comparative |
|---|---|---|---|---|---|---|---|---|---|
| | | 1 | 2 | 3 | 4 | 5 | 6 | Example 1 | Example 2 |
| Evaluation of dispersibility | | Good | Good | Good | Good | Good | Good | Bad | Bad |
| Evaluation of curability | | 96% | 94% | 90% | 93% | 90% | 88% | 74% | 70% |
| Evaluation of | Wavelength | 536 nm | 536 nm | 537 nm | 537 nm | 537 nm | 538 nm | 541 nm | 544 nm |
| luminous | Half band | 40 nm | 41 nm | 40 nm | 42 nm | 42 nm | 41 nm | 48 nm | 49 nm |
| properties | width | | | | | | | | |
| | Quantum | 62% | 63% | 66% | 60% | 58% | 63% | 31% | 22% |
| | efficiency | | | | | | | | |

| | | | | | | | | |
|---|---|---|---|---|---|---|---|---|
| Evaluation of reliability | −6% | −5% | −2% | −8% | −6% | −3% | −41% | −48% |

From the results in Table 1, it was confirmed that aggregation occurred in Comparative Examples, which caused a shift to long-wavelength in the emission wavelength and an increase in the half band width. Furthermore, a deterioration in emission intensity due to a reliability test and decrease in quantum yield were confirmed also.

On the other hand, no aggregates were observed in Examples, and changes in luminous properties is considered to be reduced. Also, when compared with Comparative Examples in the reliability test results, it can be seen that Examples all have improved stability and changes over time are reduced.

As described above, it has been confirmed that using the inventive curable resin composition made it possible to obtain a wavelength conversion material having stable luminous properties and high reliability.

The present description includes the following embodiments.
[1]: A curable resin composition comprising a quantum dot, wherein the curable resin composition is a mixture of a thermosetting resin and a silsesquioxane polymer in which the quantum dot is copolymerized with silsesquioxane.
[2]: A curable resin composition comprising a quantum dot, wherein the curable resin composition is a mixture of a thermosetting resin and a silsesquioxane polymer in which the quantum dot is copolymerized with alkoxysilane.
[3]: The curable resin composition of the above [1] or [2], wherein the quantum dot is surface-modified with a silane coupling agent.
[4]: The curable resin composition of the above [2], wherein the alkoxysilane comprises two or more kinds of alkoxysilanes each having a different functional group.
[5]: The curable resin composition of the above [2] or [4], wherein the alkoxysilane comprises at least one or more kinds of alkoxysilanes of monoalkoxysilane, dialkoxysilane, and trialkoxysilane.
[6]: The curable resin composition of the above [3], wherein the silane coupling agent comprises any one or more kinds of an amino group, a thiol group, a carboxy group, a phosphino group, a phosphine oxide group, and an ammonium ion.
[7]: The curable resin composition of the above [1], wherein the silsesquioxane has any one or more reactive substituents of a vinyl group, an acrylic group, a methacrylic group, a hydroxy group, a phenolic hydroxy group, an epoxy group, and a glycidyl group, as a functional group.
[8]: The curable resin composition of the above [2], wherein the alkoxysilane has any one or more reactive substituents of a vinyl group, an acrylic group, a methacrylic group, a hydroxy group, a phenolic hydroxy group, an epoxy group, and a glycidyl group, as a functional group.
[9]: The curable resin composition of the above [1], [2], [3], [4], [5], [6], [7], or [8], wherein the thermosetting resin is an acrylic resin having a (meth)acryloyl group in a side chain.

[10]: The curable resin composition of the above [1], [2], [3], [4], [5], [6], [7], or [8], wherein the thermosetting resin is an acid-crosslinkable group-containing silicone resin.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1. A curable resin composition comprising a quantum dot, wherein the curable resin composition is a mixture of a thermosetting resin and a silsesquioxane polymer in which the quantum dot is copolymerized with silsesquioxane.

2. A curable resin composition comprising a quantum dot, wherein the curable resin composition is a mixture of a thermosetting resin and a silsesquioxane polymer in which the quantum dot is copolymerized with alkoxysilane.

3. The curable resin composition according to claim 1, wherein the quantum dot is surface-modified with a silane coupling agent.

4. The curable resin composition according to claim 2, wherein the quantum dot is surface-modified with a silane coupling agent.

5. The curable resin composition according to claim 2, wherein the alkoxysilane comprises two or more kinds of alkoxysilanes each having a different functional group.

6. The curable resin composition according to claim 2, wherein the alkoxysilane comprises at least one or more kinds of alkoxysilanes of monoalkoxysilane, dialkoxysilane, and trialkoxysilane.

7. The curable resin composition according to claim 5, wherein the alkoxysilane comprises at least one or more kinds of alkoxysilane of monoalkoxysilane, dialkoxysilane, and trialkoxysilane.

8. The curable resin composition according to claim 3, wherein the silane coupling agent comprises any one or more kinds of an amino group, a thiol group, a carboxy group, a phosphino group, a phosphine oxide group, and an ammonium ion.

9. The curable resin composition according to claim 4, wherein the silane coupling agent comprises any one or more kinds of an amino group, a thiol group, a carboxy group, a phosphino group, a phosphine oxide group, and an ammonium ion.

10. The curable resin composition according to claim 1, wherein the silsesquioxane has any one or more reactive substituents of a vinyl group, an acrylic group, a methacrylic group, a hydroxy group, a phenolic hydroxy group, an epoxy group, and a glycidyl group, as a functional group.

11. The curable resin composition according to claim 2, wherein the alkoxysilane has any one or more reactive substituents of a vinyl group, an acrylic group, a methacrylic group, a hydroxy group, a phenolic hydroxy group, an epoxy group, and a glycidyl group, as a functional group.

12. The curable resin composition according to claim 1, wherein the thermosetting resin is an acrylic resin having a (meth)acryloyl group in a side chain.

13. The curable resin composition according to claim 1, wherein the thermosetting resin is an acid-crosslinkable group-containing silicone resin.
